(19) United States
(12) Patent Application Publication
(10) Pub. No.: US 2021/0166548 A1
(43) Pub. Date: Jun. 3, 2021

(54) ADJUSTING AN ALERT THRESHOLD

(71) Applicant: Hewlett-Packard Development Company, L.P., Spring, TX (US)

(72) Inventors: Daniel Ellam, Bristol (GB); Augusto Queiroz de Macedo, Porto Alegre (BR); Matheus Eichelberger, Porto Alegre (BR)

(73) Assignee: Hewlett-Packard Development Company, L.P., Spring, TX (US)

(21) Appl. No.: 17/047,310

(22) PCT Filed: Jul. 23, 2018
(86) PCT No.: PCT/US2018/043329

§ 371 Date: Oct. 13, 2020

(51) Int. Cl. G08B 21/18; G06F 21/55; G06F 11/34

(52) U.S. Cl. CPC G08B 21/182; G06F 2221/034; G06F 11/3409; G06F 21/554

(57) ABSTRACT

In an example, a method includes monitoring, by at least one processor, a computing system. An alert related to the computing system may be generated based on a threshold value. An analysts handling of the alert may be monitored and, based on the analysts handling of the alert, the threshold value for generating alerts may be adjusted.

### BACKGROUND

Computing systems such as computers, computer networks and the like may include monitoring services and systems. Monitoring systems for computing systems can generate alerts which may indicate, for example, a security threat, device health, software status and/or performance, or device failure or, in some examples, an indication that a device is likely to fail or is under stress.

### BRIEF DESCRIPTION OF DRAWINGS

Non-limiting examples will now be described with reference to the accompanying drawings, in which:

FIG. 1 is a flowchart of an example method of monitoring a computing system;

FIG. 2 is a flowchart of another example method for monitoring a computing system;

FIG. 3 is an example of a machine readable medium in association with a processor; and

FIG. 4 is an example monitoring apparatus.

### DETAILED DESCRIPTION

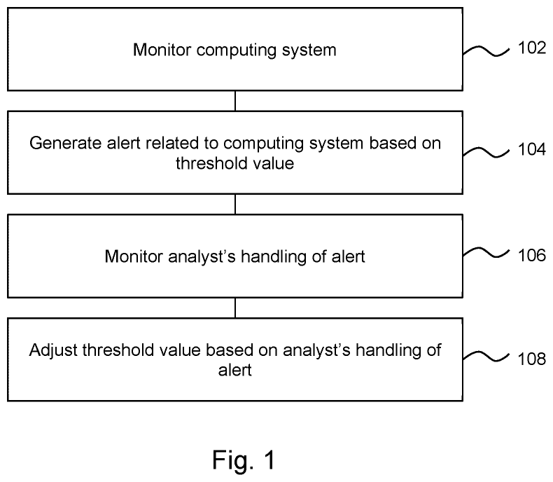

FIG. 1 is an example of a method, which may be a computer implemented method, and may be a method for dynamically adjusting a threshold value for generating an alert within a computing system. The method may be carried out using at least one processor.

The method comprises, in block 102, monitoring a computing system. In some examples, the computing system may comprise at least one computing device. In some examples, the computing system may comprise at least one computing device associated with peripheral device(s) such as printer(s), speaker(s), headset(s), telephone(s) or the like. In some examples, the computing system may comprise computing and/or peripheral devices connected over a network, which may for example be a wired or wireless network, local area network, a wide area network or the like. In some examples, the computing system may comprise at least one ‘device as a service’ (DaaS), in which devices used within the computing system are monitored remotely, for example to remove a maintenance burden from an entity utilising the computing system (also referred to as ‘the organisation’ herein).

Block 104 comprises generating an alert related to the computing system based on a threshold value.

In some examples, the alert may be a security alert. For example, an alert may be generated following detection of suspicious user behaviour (for example, downloading or uploading large volumes of data), data content (for example, potentially malicious or offensive material being accessed or received), or the like. In some examples, alerts may be generated following a ‘system scan’, which may scan all or part of the computing system to identify data matching predetermined characteristics, which may be characteristic of malicious code or other data. An alert threshold may be set based on a likelihood that a file may be malicious (for example, that it shares characteristics with known malicious files). In another example, the characteristics of recent login patterns may be assessed to detect potential system intrusions, and the like, and an alert threshold may be set based on a threshold likelihood that a system intrusion has been attempted.

In some examples, the alert may be a hardware alert, for example indicating that hardware usage is high (for example, a processor is subjected to a number of requests which is close to its maximum number of requests for a prolonged period of time, or that a bandwidth of a communication system is substantially exhausted). For example, an alert threshold value may be set based on a percentage of time for which a usage level is exceeded. In other examples, a hardware alert may indicate that device servicing is due, or that replacement of hardware should be carried out. In such examples, the threshold value may be time period since the last servicing/replacement. In other examples, the alert may relate to physical characteristics of hardware. For example, an alert may be generated to indicate that a battery is not reaching a specified charge capacity (i.e. the threshold value may be related to the maximum charge reached), which may be predictive of potential failure and/or indicative of degradation. In another example, the thermal characteristics of a device, such as an operating thermal profile, may be monitored and compared to predetermined characteristics to determine if the thermal characteristics are outside of normal bounds, wherein the alert threshold may relate to a predetermined difference between measured and expected thermal characteristics.

In some examples, an alert may be associated with software, for example indicating that software is outdated and/or incompatible with other components and/or software in use within the computing system or performance.

In some examples, a ‘health assessment’ may be carried out for apparatus, which may assess various system characteristics (for example, any combination of software versions, software behaviour, use level, measured physical characteristics and the like) to produce a health score. When the health score is below a threshold, an alert may be generated.

The threshold value for generating alerts may be indicative of the level of risk that a potentially negative event will occur without action being taken. For example, an alert may be generated in the case of a pattern match between user behaviour and suspect user behaviour. However, this match need not be a 100% match. The user behaviour may exhibit some of the characteristics associated with suspect user behaviour but not others. Therefore, a threshold may be set to be, for example, a 70% match, and an alert may be generated when a user's behaviour has a 70% or greater match with a suspect user behaviour pattern. In other systems, this threshold may be set differently. For example, if a user is trusted, and/or is relatively likely to exhibit behaviour which could match a suspect user behaviour pattern, but which is actually likely to be benevolent, the threshold could be set to 90%. Alternatively, for a relatively new user of a system, or in a circumstance where security is highly important, the threshold could be set lower, for example at 50%. In such cases, slightly suspect behaviour may generate an alert, although there is a relatively high probability that the behaviour is acceptable. In other examples, a threshold value may relate to an acceptable departure from ‘nominal’ values. In other examples, a threshold value may for example relate to the number of software and/or hardware components which are outdated, or associated with compatibility issues, or the like. Other threshold values may be specified in some other way.

In some examples, a number of parameters are monitored and compared to respective threshold values. Setting such threshold values is often carried out at a system level and can be wholly or relatively static. In some examples, monitoring systems which generate alerts may be provided to a plurality of businesses with a predetermined, and pre-set, threshold. In other examples, a risk level may be set for a computing system, which may in turn reflect an acceptable risk level for that computing system and/or the entity operating the system (the organisation'), and the threshold values may be set on this basis.

Block 106 comprises monitoring an analyst's handling of the alert. An analyst may be a trained user, and/or a user who is tasked with monitoring and responding to alerts. In some examples, the monitoring may comprise monitoring the time taken by the analyst to address the alert. For example, some alerts may be ignored for a period of time before being addressed. This may indirectly provide an indication as to whether the alert is considered to be of low or high importance (or of low or high urgency) by the analyst/the organisation. When an alert is neglected for a period of time, this may be indicative that an analyst is assessing the alert to be of low importance, or at least of low urgency. This may in turn be a reflection of the ‘risk posture’ of the organisation, rather than a judgement made in isolation by the analyst. In some examples, alerts may be ignored or dismissed altogether, also providing an indication of the analyst's/organisation's assessment of the alert.

In some examples, in block 106, the relative handling of alerts may be considered. For example, an analyst may prioritise a plurality of alerts presented over a particular timeframe, for example choosing to deal with a later-issued alert in favour of an earlier-issued alert. This may indicate that the analyst/organisation considers the later issued alert to be of greater importance.

In block 108, the threshold value for generating alerts is adjusted based on the analyst's handling of the alert. In practice, it may be that a plurality (for example, tens, hundreds or thousands) of alerts are issued, the handling of each of these alerts is monitored and that the result is considered in aggregate for adjusting a threshold. The alert threshold value may thereby be adjusted based on machine learning principles.

As noted above, in some examples, a threshold value may be set at a predetermined level, which may apply to one or a plurality of computing systems. This may mean that the threshold value is set based on what amounts to a guess of a suitable threshold value. This may not take into account variations in the customer's ability to triage events, and may not prove optimal in terms of performance. In some examples, a monitoring method may be too reactive, i.e. the threshold value is set too low. While this may result in an apparently ‘safe’ system, as few potentially adverse events will be undetected, when an alert threshold is set too low, alerts may be generated at a rate to result in ‘alert fatigue’ in analysts.

In general, in such monitoring systems, there is a trade-off between false positive (FP) alerts with missed, false negative (FN) alerts. Monitoring systems may be based on behavioural and machine learning algorithms, especially in heavily automated solutions like Device-as-a-Service (DaaS). While these systems have many benefits, alert fatigue and missed detections can still result. False positives in particular lead to alert fatigue on the part of the analyst(s).

However, by utilising the system of FIG. 1, metrics relating to an actual response in terms of handling the alerts may be gathered to assist in identifying appropriate threshold values, for example on an individual computing system, per-entity, per-analyst and/or per-alert category basis.

A system which produces a high number of false positives can be considered to have poor precision. Conversely, a monitoring system which produces a high number of false negatives may be considered as having poor recall. If an analyst receives too many alerts, they may simply ignore the algorithm output as being too noisy and ignored. If the monitoring system misses detections, it may be dismissed as unreliable by analysts and again as an end result may be ignored.

The method of FIG. 1 proposes monitoring the analyst's actual handling of alerts. For example, if a high number of alerts are ignored, this may indicate that the analyst is suffering from alert fatigue, or the ‘risk posture’ of the organisation is relatively relaxed in relation to alerts (or to a type of alert) and at least one threshold value may be changed such that fewer events trigger an alert. Changing the threshold value(s) to provide the analyst/organisation with fewer, and/or more targeted, alerts, may in in turn provide more value. As, prior to threshold values being adjusted, any threats may be dealt with inadequately, adjusting the threshold in such an example may counterintuitively increase the security of the system.

Conversely, when all alerts are promptly addressed, this may be indicative that the security of the computing system is of high importance to a particular analyst/the organisation. In such examples, it may be appropriate to adjust the threshold value such that more alerts are generated.

In summary, according the methods set out herein, historic alert handling (for example, aggregated handling results) may be indicative of how high the alert rate may be until there is little or no benefit in increasing the alert rate further (in some examples, this may be equivalent to how low a threshold value may be set until there is little or no benefit in decreasing it further). In some examples, a threshold value may be set so as to achieve or tend towards a target alert rate.

As is explained in greater detail below, other criteria, such as the handling history in relation to particular alert classes, categories or types and/or analysts may also be considered, as may the number of analysts logged on and available to act on alerts.

In some examples, there may be predetermined criteria, such as an acceptable minimum level of risk within that computing system.

In some examples, the threshold values may be adjusted without user intervention, for example automatically or dynamically based on alert handling, which may also be referred to as triage.

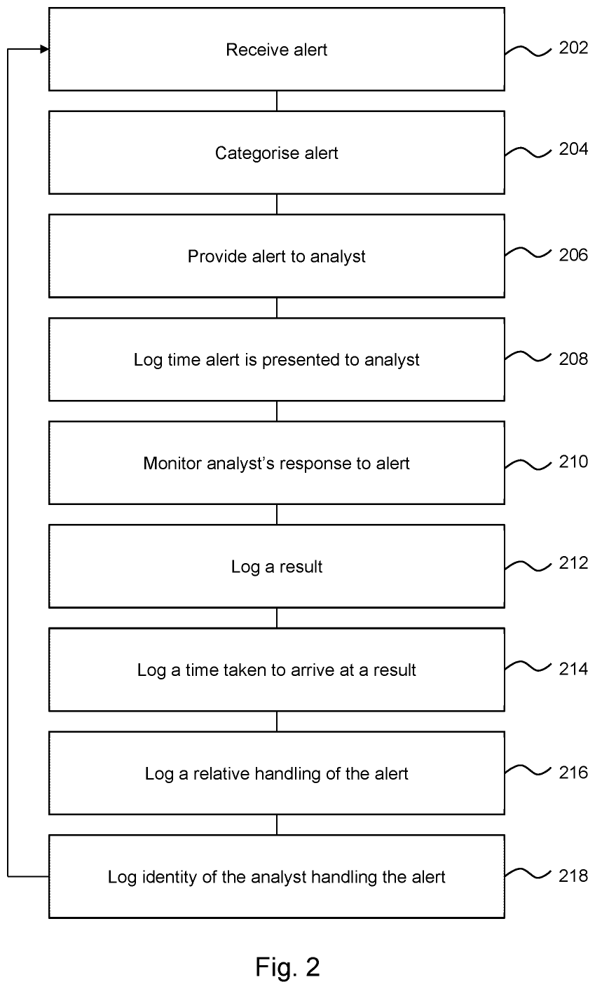

FIG. 2 shows an example in which there is a first category of alert and a second category of alert. For example, the first category of alert may be a security alert and the second category may be a hardware health alert, indicating a hardware fault, unexpected hardware behaviour, hardware stress, hardware age exceeding a threshold or the like. In some examples, more than two categories may be considered. In some examples, at least one category may be associated with, for example a user of the computing system. For example, users may be considered individually and/or in groups or sets. The alert type in such an example may indicate a group and/or identity of user. In other examples, the category may be associated with device type, device or software health, or some other category. In some examples, a category of alert may relate to suspicious web traffic. In some examples, a category may be relate to suspicious email traffic. In some examples, a category may be related to software health (for example including an indication of the currency of software, and other characteristics). In some examples, a category may relate to software performance, such as whether software is behaving outside of expected parameters and/or has degraded performance over time

The alerts may be categorised in various manners and these are simply examples. In some examples, the categories may be predetermined and/or static. In some examples, the categories may be allocated, for example by an analyst, on the fly. In some examples, the categories may be ‘learnt’, for example using machine learning techniques based on analyst categorisation and/or handling. In block 202, an alert is received and, in block 204, the alert is categorised. For example, it may be categorised as one of a security alert, a hardware health alert, a specific user alert or in some other category. In block 206, the alert is provided to an analyst. For example, in some practical systems, an analyst may be presented with an interface, for example comprising a list or ‘dashboard’ of alerts. These may for example be presented in a list format with some information being provided about each alert. In some examples, an interface through which an analyst is presented with information about the alert may also provide a toolset for triaging and handling the alert, such as a query language to query databases containing raw, aggregated and enrichment device data. Block 208 comprises logging the time at which the alert is presented to the analyst.

Block 210 comprises monitoring an analyst's response to the alert. For example, in the case of a security alert, an analyst may investigate the origin of the alert. There may be a number of actions that an analyst may take as part of the handling of the alert. This may comprise ‘raising a ticket’ in a ticketing system for another analyst or engineer to handle. For example, an action may comprise, following an inspection, allowing a file which was the source of an alert to remain or to enter a computing system, or removing from the computing system/preventing the file from entering the computing system. In another example, if the alert is associated with user behaviour, an analyst may act to restrict or remove another user's access to the computing system, or alternatively may conclude that the user behaviour is acceptable. In the case of a hardware health alert, there may be an indication that, for example excessive demands of been placed on a CPU or communication link within the computing system. In such examples, the analyst may choose to tolerate such conditions, or may indicate that the computing system should be provided with increased capacity. In other examples, the age of a device or component may trigger an alert and, in such a case, the analyst may choose to delay replacement of the device or the component, or may act to secure a replacement.

Block 212 comprises logging a result. For example the result may be that the file is allowed and/or it is concluded that a user's behaviour is acceptable. In another example, a result may be that a high stress condition is to be tolerated or that system capacity is to be upgraded. In another example, a failing or failed component may be replaced or deferred (or even ignored). In some examples, a result may comprise, for example, an order being placed for a replacement component. In some examples, the result may be a binary result (e.g. action/no action, yes/no, 0/1, acceptable/unacceptable, etc.)

In some examples, the result may indicate if the alert was a ‘false positive’. For example, where receipt of a data file is prevented, it is concluded that the user's behaviour is unacceptable, additional capacity is requested and/or a replacement is ordered, it may be concluded that the alert was appropriate. However, another outcome (such as the analyst dismissing be alert without taking additional action) may be indicative that the alert was a false positive.

Block 214 comprises logging a time taken to arrive at a result. In some examples, there may be a ‘timeout’ feature such that, when a predetermined time limit is reached, it is concluded that the alert has been ignored. The time taken may be a difference between the time at which the result is logged (in block 212) and the time at which the alert is presented to the analyst (in block 208). For example, this may utilise a system clock.

Block 216 comprises logging a relative handling of the alert. In particular, it is determined whether the alert was handled ahead of other alerts presented to the analyst over a timeframe.

Block 218 comprises logging the identity of the analyst handling the alert, and, in this example, the method then loops back to block 202 when another alert is received.

Over time, the logs provide a record of an analyst's handling, on a per-alert category and per-analyst basis. This information may be used in turn to adjust an alert threshold value.

For example, where a particular analyst deals with alerts quickly and consistently, for example completing a list of alerts within a timeframe or such that the overall number of open alerts is generally static rather than increasing over time, when that analyst is logged on, a threshold value may be reduced such that more alerts may be generated without undue risk of alert fatigue.

Where a particular category of alert is considered ahead of, or in preference to an alert in another category, this may indicate that the threshold values for the second category should be adjusted differently. For example, where security alerts are addressed immediately, even when older hardware health alerts are open, this may indicate that the controlling entity of the computing system prioritises security over device operability (or more generally, category A alerts are prioritised over category B alerts by entity Y). For example, the entity may tolerate some device downtime. However, another entity may prioritise device alert over security alerts (or more generally, category B alerts are prioritised over category A alerts by entity Z). In such cases, the relative relationship of a first threshold value associated with security alerts and a second threshold value associated with hardware health alerts may be adjusted, for example being adjusted in favour of the alerts which are prioritised such that the rate of such prioritised alerts increases.

For example, given a finite amount of analyst time, it may be inferred from an analyst's tendency to prioritise alerts in category A over alerts in category B that time will be better utilised if there are more alerts in category A than alerts in category B.

To consider a particular example, consider a monitoring system which generates alerts to two analysts, each spending 8 hours per day triaging alerts. This gives 16 hours analysis time per day

In this case, there are three alert subsystems, each generating alerts in categories A, B and C. Log records may show that the analysts handle alerts in categories A, B and C in the ratio of 1:1:2. So for every alert from category A or B, the analysts typically address two category C alerts. In addition, on average, each alert in category A is handled in 5 minutes, each alert in category B is handled in 10 minutes, and each alert in category C is handled in 15 minutes.

In this example, for every 5 minutes spent addressing an alert from A, the analysts tend to be willing to spend 30 (2*15) minutes addressing category C alerts.

Given 16 hours of analyst time, and the above ratios, it may be intended to present an analyst with approximately 21 alerts from category A, 21 alerts from category B, and 42 alerts from category C. (every 4 alerts triaged will take 45 minutes; 5+10+2*15. 16 hours/0.75 hours ˜21 lots of 4 alerts). The alert threshold may be adjusted (in some examples over a number of iterations) so as to generate alerts at that rate (on average), in some examples based on a historical rate, and/or based on a projected or anticipated effect of a threshold adjustment to the alert rate.

Other examples may consider the behaviour of the analyst(s) individually.

In some examples, Precision-Recall (P-R) curves (which show the trade-off between precision and recall for different threshold values) for each alert category to determine a suitable adjustment to a threshold value—for example, in the case of categories A,B and C above, a P-R curve may influence, or weight, the ratio 1:1:2 above. For instance, if a P-R curve shows that precision drops substantially for A with no gains in recall after 15 alerts in a given time window, then the number of alerts for A may be maintained below a threshold, especially if this time can be used to increase recall for either categories B or C with little loss to precision. In another example, if historic P-R scores show that adjusting the threshold in a particular direction (e.g. increasing or decreasing) for category A to increase the alert rate, for example to generate around 21 alerts in the time window does not result in a substantive benefit, the adjustment of the threshold in that direction for A may be retained within limits, saving handling time (which may be reallocated to another category such as B), since adjusting the threshold to increase the alert rate increases recall while maintaining precision.

In general, such trade-offs can be treated as a minimisation problem.

The speed with which an alert is addressed may also be indicative of the perceived importance by the analyst/organisation, and therefore the alert threshold may be adjusted accordingly.

In some examples, where the alert category is associated with a user or a user type, the threshold value(s) for just one user identity/set may be adjusted, and/or the threshold value(s) may be adjusted differently.

For example, one set of users may undertake actions which, while not allowed in general, are allowed for that set, and therefore an alert originating from a device controlled by a user of the set may be dismissed by the analyst, but will result in action if it is received from a device controlled by a user of another set. In such cases, the threshold values for each of the sets may be adjusted to change their relationship. In another example, some users may receive a higher priority response than others, indicating that these users may be ‘business critical’. In such a case, the alert threshold may be adjusted for that set such that more alerts are generated (the alert rate is increased). In some examples, some device types may be prioritised over others, which may indicate that the device is ‘single point of failure’ for the computing system (rather than being, for example of a pool of equivalent device) or otherwise indicates the importance of a device within the computing system, which may again lead to an adjustment of a threshold value to result in an increase in the alert rate for that type of device. In some examples, the alert threshold associated with such devices may be altered independently from the alert threshold of other device types. In some examples, the high priority user(s) and/or device(s) may form a new ‘learnt’ alert category. Other alert categories may be derived in a similar manner.

In some examples, where a rate of false positives is relatively high, the alert threshold may be adjusted such that fewer events trigger an alert to prevent such a high rate. In some examples, when no, or very few, false positives are seen, this may indicate that the threshold is set to generate too few alerts, and that there is a risk of missing genuine issues within the computing system. In such an example, the alert threshold may be altered to increase the number of events which result in an alert being generated.

The impact of a particular finding (e.g. false positive rate, ignored alerts, prioritised alerts, etc.) on a threshold value may be predetermined, and/or may vary as the method is used. For example, an initial adjustment to the threshold value may be relatively coarse, with adjustments becoming smaller as a ‘steady state’ condition is reached. This allows convergence on a suitable threshold value over time. In some examples, the adjustments may be made in the context of a system state. For example, after a steady state threshold value has been reached, this may only shift significantly in the event of prolonged action/inaction by the analyst which goes against historical behaviour—short term aberrant handling behaviour may for example be ignored. However, where there is a state change, for example new hardware/software is deployed companywide, or new security measures are implemented, etc., a larger adjustment may be made, and/or the value may be adjusted sooner than in the steady state case.

In some examples, at least a threshold number of events (or, in some examples, events in a particular category) may be logged before any change is made to a threshold value. For example, this may be 10 events, 50 events, 100 events, 500 events, 1000 events or the like. In some examples, a threshold time (such as a week, two weeks, a month or the like) may be allowed to pass before any change is made to a threshold value. Such time and/or event count thresholds may be applied individually or in combination. Once a qualifying set of alerts has accrued, the results of the handling of the alerts may be aggregated, from which it may be determined if at least one current threshold value (e.g. a threshold for a given alert category) is inappropriate in that computing system, and a shift may be made accordingly.

In some examples, the threshold value may be updated after a predetermined period, for example daily, weekly, monthly or the like.

In some examples, there may be an assessment of the likelihood that the current threshold value is not meeting the organisation's needs. In such examples, the threshold value may be updated when the likelihood exceeds a threshold. In some examples, the number of log events, the elapse of a time period and/or a likelihood that that the current threshold value is not meeting the organisation's needs exceeding a threshold may automatically trigger a change in the threshold.

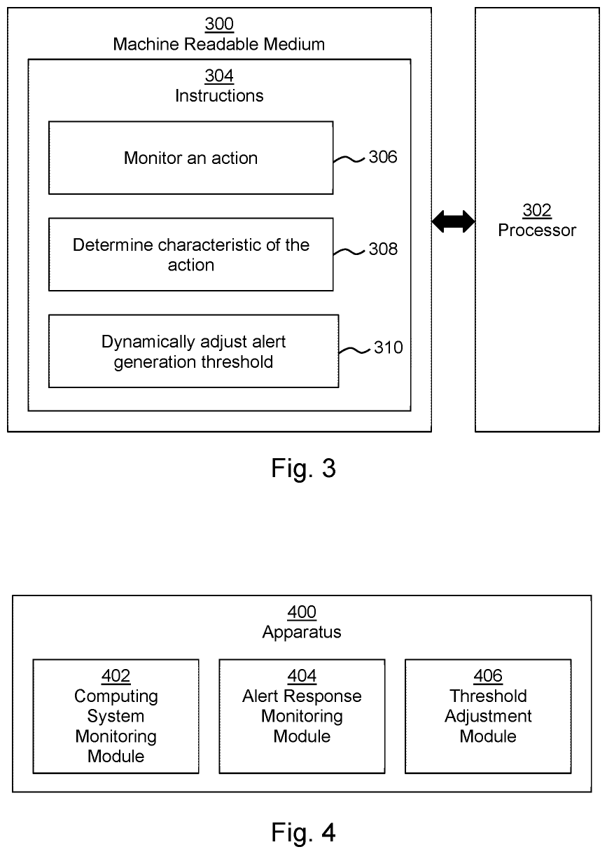

FIG. 3 shows an example of tangible machine-readable medium 300 in association with a processor 302. The machine-readable medium 300 stores instructions 304 (in examples, in a non-transitory manner) which when executed by the processor 302 cause the processor 302 to carry out actions. In this example, the instructions 304 include instructions 306 to cause the processor 302 to monitor an action of an analyst addressing an alert generated by a monitoring system, instructions 308 to cause the processor 302 to determine a characteristic of the action; and instructions 310 to cause the processor 302 to, based on the determined characteristic, dynamically adjust an alert generation threshold of the monitoring system. The action may be an action taken in alert handling.

For example, the instructions 308 to determine a characteristic of the action may comprise instructions to determine a length of time to completely address the alert and/or instructions to determine if an issue indicated by the alert is resolved or dismissed. Other examples of actions relating to alert handling have been discussed above. In some examples, the characteristic may comprise the result of at least one action taken in alert handling, as discussed in relation to block 212 above.

In some examples, the instructions 310 to dynamically adjust an alert generation threshold of the monitoring system may comprise instructions to adjust the threshold to decrease an alert generation rate when analyst handling includes a high proportion of dismissed or ignored alerts. In some examples, the instructions 310 to dynamically adjust an alert generation threshold of the monitoring system may comprise instructions to adjust the threshold to decrease an alert generation rate when analyst handling includes a high proportion of false positive alerts (for example, alerts which result in no action despite inspection by an analyst).

In some examples, the instructions 310 to dynamically adjust an alert generation threshold of the monitoring system are based on a plurality of characteristics determined by monitoring actions of an analyst addressing a plurality of alerts. In this way a ‘history’ of analyst interaction with the system may be used when altering the threshold, rather than responding to a single event. Dynamically adjusting the threshold may comprise adjusting the threshold without requiring a restart or a reboot or the like.

In some examples, the instructions 310 to dynamically adjust an alert generation threshold of the monitoring system comprise instructions to dynamically adjust a relationship between a plurality of alert generation threshold values of the monitoring system based on characteristics determined by monitoring an action of an analyst addressing alerts in each of a plurality of categories, each of the categories being associated with an alert generation threshold. For example, if an analyst is regularly prioritising a first type/category of alert over a second type/category of alert, the threshold for the first type/category of alert may be adjusted to increase the alert rate for the first type/category and/or the threshold for the second type/category of alert may be adjusted to reduce the alert rate for the second type/category of alert. In some examples, the categories may be derived from user handling of the alerts.

In other examples, the instructions 304 may comprise instructions to carry out any, or any combination of, of the blocks of FIG. 1 or FIG. 2.

FIG. 4 is an example of a monitoring apparatus 400 comprising a computing system monitoring module 402, an alert response monitoring module 404 and a threshold adjustment module 406. In some examples, the monitoring apparatus 400 comprises processing circuitry and/or at least one processor.

In use of the monitoring apparatus 400, the computing system monitoring module 402 monitors a risk level within a computing system, and generates an alert when the risk level exceeds a threshold, the alert response monitoring module 404 monitors an analyst handling of each of a plurality of alerts and the threshold adjustment module 406 adjusts the threshold used in the computing system monitoring module 402 based on the analyst handling of the alerts.

In some examples, in use of the monitoring apparatus 400, the threshold adjustment module 406 adjusts the threshold to decrease an alert generation rate when analyst handling includes a high proportion of dismissed or ignored alerts, and/or when analyst handling indicates a high proportion of false positive alerts. In some examples, in use of the monitoring apparatus 400, the threshold adjustment module 406 adjusts the threshold to increase an alert generation rate the threshold when all, or a high proportion of alerts are handled within a predetermined time frame. ‘High’ in this context may be assessed relative to a threshold (i.e. the proportion is high when it exceeds a predetermined threshold). The threshold may be adjusted dynamically.

In some examples, the threshold adjustment module 406 may alter the threshold based on the number and/or identity of logged-in analysts (i.e. the analysts who are actively assessing, triaging/handling alerts at a given instant). For example, in use of the monitoring apparatus 400, the alert response monitoring module 404 may monitor an analyst handling of each of a plurality of alerts for each of a plurality of analyst identities and determine, for each analyst identity, an analyst handling history. The threshold adjustment module 406 may in some examples adjust the threshold based on an analyst identity of a logged-in analyst and the analyst handling history associated with that analyst identity.

In some examples, in use of the monitoring apparatus 400, the alert response monitoring module 404 may monitor an analyst handling of each of a plurality of alerts for each of a plurality of alert categories and determine, for each alert category, a category handling history. In such examples, the threshold adjustment module 408 may adjust the threshold based on an alert category and the category handling history associated with that alert category.

In some examples, the threshold may be adjusted based on a combination of an analyst identity and/or an alert category and/or additional factors.

The machine readable medium 300 of the example of FIG. 3 may comprise instructions to provide the computing system monitoring module 402, alert response monitoring module 404 and/or the threshold adjustment module 406.

In some examples, the apparatus 400 may carry out any, or any combination of, of the blocks of FIG. 1 or FIG. 2.

Examples in the present disclosure can be provided as methods, systems or machine readable instructions, such as any combination of software, hardware, firmware or the like. Such machine readable instructions may be included on a computer readable storage medium (including but not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each block in the flow charts and/or block diagrams, as well as combinations of the blocks in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices (for example, the computing system monitoring module 402, alert response monitoring module 404 and/or threshold adjustment module 406) may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by block(s) in the flow charts and/or in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method comprising:
monitoring, by at least one processor, a computing system;
generating, by at least one processor, an alert related to the computing system based on a threshold value;
monitoring, by at least one processor, an analyst's handling of the alert; and
based on the analyst's handling of the alert, adjusting, by at least one processor, the threshold value for generating alerts.

2. A method according to claim 1 wherein monitoring an analyst's handling of the alert comprises monitoring a time taken to resolve an alert.

3. A method according to claim 1 wherein monitoring an analyst's handling of the alert comprises determining if an analyst addresses a subject of the alert or dismisses an alert.

4. A method according to claim 1 further comprising adjusting the threshold value based on at least one of an analyst identity and a number of analysts handling alerts.

5. A method according to claim 1 comprising:
generating a plurality of alerts in a first category based on a first threshold value;
generating a plurality of alerts in a second category based on a second threshold value, wherein monitoring an analyst's handling of the alert is carried out separately for each alert category;
the method further comprising adjusting a relative relationship between the first and second threshold value based on a relative handling of the alerts of each category.

6. A tangible machine-readable medium storing instructions which when executed by a processor cause the processor to:
monitor an action of an analyst addressing an alert generated by a monitoring system;
determine a characteristic of the action; and
based on the determined characteristic, dynamically adjust an alert generation threshold of the monitoring system.

7. The tangible machine-readable medium of claim 6 wherein the instructions to determine a characteristic of the action comprise instructions to determine a length of time to completely address the alert.

8. The tangible machine-readable medium of claim 6 wherein the instructions to determine a characteristic of the action comprise instructions to determine if an issue indicated by the alert is resolved or dismissed.

9. The tangible machine-readable medium of claim 6 wherein the instructions to dynamically adjust an alert generation threshold of the monitoring system comprise instructions to dynamically adjust the alert generation threshold based on a plurality of characteristics determined by monitoring actions of analyst(s) addressing a plurality of alerts.

10. The tangible machine-readable medium of claim 6 wherein the instructions to dynamically adjust an alert generation threshold comprise instructions to dynamically adjust a relationship between a plurality of alert generation threshold values of the monitoring system based on characteristics determined by monitoring actions of analyst(s) addressing alerts in each of a plurality of categories, each of the categories being associated with an alert generation threshold.

11. A monitoring apparatus comprising:
a computing system monitoring module to monitor a risk level within a computing system, and to generate an alert when the risk level exceeds a threshold;
an alert response monitoring module to monitor an analyst handling of each of a plurality of alerts; and
a threshold adjustment module to adjust a threshold used in the computing system monitoring module based on the analyst handling of the alerts.

12. A monitoring apparatus according to claim 11 in which the threshold adjustment module is to adjust the threshold to decrease an alert generation rate when analyst handling includes a proportion of dismissed or ignored alerts which exceeds a threshold.

13. A monitoring apparatus according to claim 11 in which the threshold adjustment module is to adjust the threshold to decrease an alert generation rate when analyst handling indicates that a proportion of false positive alerts exceeds a threshold.

14. A monitoring apparatus according to claim 11 in which the alert response monitoring module is to monitor an analyst handling of each of a plurality of alerts for each of a plurality of analyst identities and to determine, for each analyst identity, an analyst handling history; and in which the threshold adjustment module is to adjust the threshold based on an analyst identity of a logged-in analyst and the analyst handling history associated with that analyst identity.

15. A monitoring apparatus according to claim 11 in which the alert response monitoring module is to monitor an analyst handling of each of a plurality of alerts for each of a plurality of alert categories and to determine, for each alert category, a category handling history; and in which the threshold adjustment module is to adjust the threshold based on an alert category and the category handling history associated with that alert category.
